(19) United States
(12) Patent Application Publication
(10) Pub. No.: US 2011/0019523 A1
(43) Pub. Date: Jan. 27, 2011

(54) INTEGRATED STANDALONE OPTICAL DISC DUPLICATION AND LABELING SYSTEM

(75) Inventors: Shuo-Wei CHANG, Alhambra, CA (US); Chia-Chun CHENG, Alhambra, CA (US)

Correspondence Address: PATENTTM.US, P. O. BOX 82788, PORTLAND, OR, 97282-0788, US

(73) Assignee: VINPOWER INC., Alhambra, CA (US)

(21) Appl. No.: 12/899,434

(22) Filed: Oct. 6, 2010

Related U.S. Application Data
(63) Continuation-in-part of application No. 12/105,653, filed on Apr. 18, 2008.

(51) Int. Cl. G11B 7/28

(52) U.S. Cl. 369/84; G9B/7.2

(57) ABSTRACT

An integrated standalone optical disc duplication and labeling system has an optical disc drive, a main controller and a command module. The optical disc drive is capable of containing an optical disc and performing either a duplication capability or a labeling capability. The main controller is connected to and operates the optical disc drive. The command module is connected to the main controller and is capable of transmitting either a duplication designating command or a labeling designating command to the main controller. The duplication designating command is used to designate the optical disc drive to perform the duplication capability. The labeling designating command is used to designate the optical disc drive to perform the labeling capability. A user acquires a single standalone system that is able to perform both duplication and labeling.

### CROSS REFERENCE

The present invention is a continuation-in-part of application Ser. No. 12/105,653 filed on Apr. 18, 2008.

### BACKGROUND OF THE INVENTION

1. Field of the Invention

The present invention relates to a system, and more particularly to an integrated standalone optical disc duplication and labeling system that is capable of recording data and printing images on optical discs.

2. Description of Related Art

Optical discs, including the format of CD, DVD, blu-ray and HD DVD, have been popular data storage and exchange mediums of today due to the increasing desire for large capacity storage media. A conventional standalone duplication system can be used to duplicate one or multiple optical discs with data.

In addition, in order to label the optical discs, a conventional approach is to label the optical discs by using direct laser labeling technology. A label side opposite to a data side of an optical disc is directly exposed to laser beams to form labels thereon by the reaction of the label side and the laser beams. A conventional approach to label the optical discs usually requires a computer to connect to and control a single optical disc drive that is capable of performing either a duplication capability to record data to the optical disc or a labeling capability to label images on the contained optical disc.

However, the conventional optical disc burner system cannot label the optical discs, and the computer with a single optical disc drive cannot duplicate or label multiple optical discs simultaneously. It is inconvenient for the user who intends to duplicate and label multiple optical discs.

To overcome the shortcomings, the present invention provides an integrated standalone optical disc duplication and labeling system to mitigate or obviate the aforementioned problems.

### SUMMARY OF THE INVENTION

The main objective of the invention is to provide an integrated standalone optical disc duplication and labeling system that is capable of recording data and printing images on optical discs.

In a preferred embodiment, the system in accordance with the present invention comprises an optical disc drive, a main controller and a command module. The optical disc drive is capable of containing an optical disc and performing either a duplication capability or a labeling capability. The main controller is connected to and operates the optical disc drive. The command module is connected to the main controller and is capable of transmitting either a duplication designating command or a labeling designating command to the main controller. The duplication designating command is used to designate the optical disc drive to perform the duplication capability. The labeling designating command is used to designate the optical disc drive to perform the labeling capability.

In another preferred embodiment, the system in accordance with the present invention comprises multiple optical disc drives, a main controller and a command module. Each optical disc drive is capable of containing an optical disc and performing either a duplication capability or a labeling capability. The main controller is connected to and operates the optical disc drives. The command module is connected to the main controller and is capable of transmitting at least one duplication designating command and at least one labeling designating command to the main controller. The at least one duplication designating command is used to designate a corresponding optical disc drive to perform the duplication capability. The at least one labeling designating command is used to designate a corresponding optical disc drive to perform the labeling capability. A user acquires a single standalone system that is able to perform both duplication and labeling.

Other objectives, advantages and novel features of the invention will become more apparent from the following detailed description when taken in conjunction with the accompanying drawings.

### BRIEF DESCRIPTION OF THE DRAWINGS

FIG. 1 is a block functional of a first embodiment of an integrated standalone optical disc duplication and labeling system in accordance with the present invention;

FIG. 2 is a block functional of a second embodiment of an integrated standalone optical disc duplication and labeling system in accordance with the present invention;

FIG. 3 is a block functional of a third embodiment of an integrated standalone optical disc duplication and labeling system in accordance with the present invention; and

FIG. 4 is a flowchart of an operating process executed by a main controller in FIG. 3.

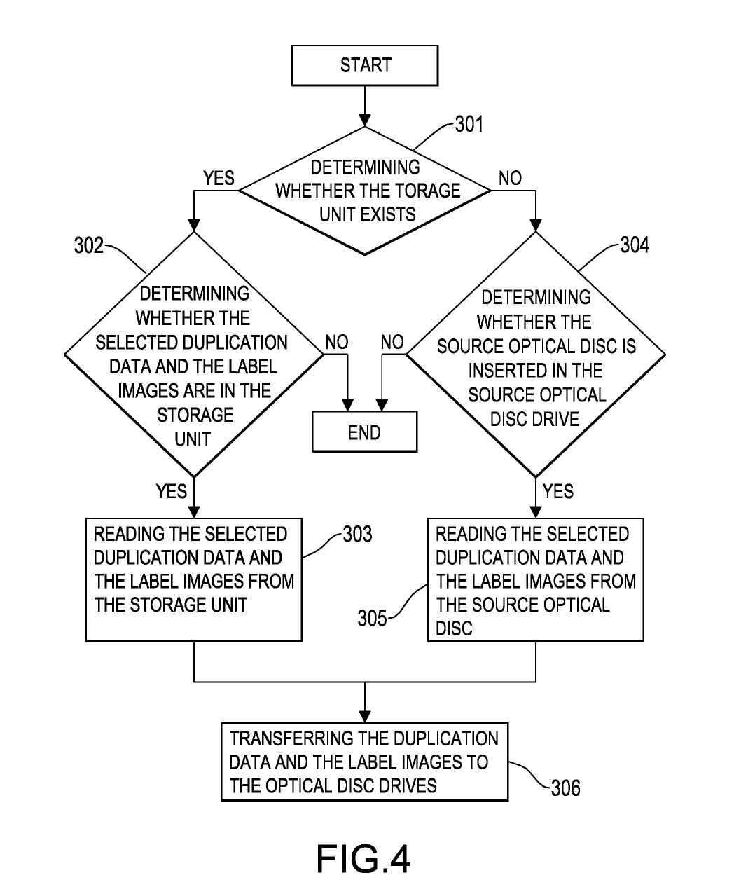

### DETAILED DESCRIPTION OF PREFERRED EMBODIMENT

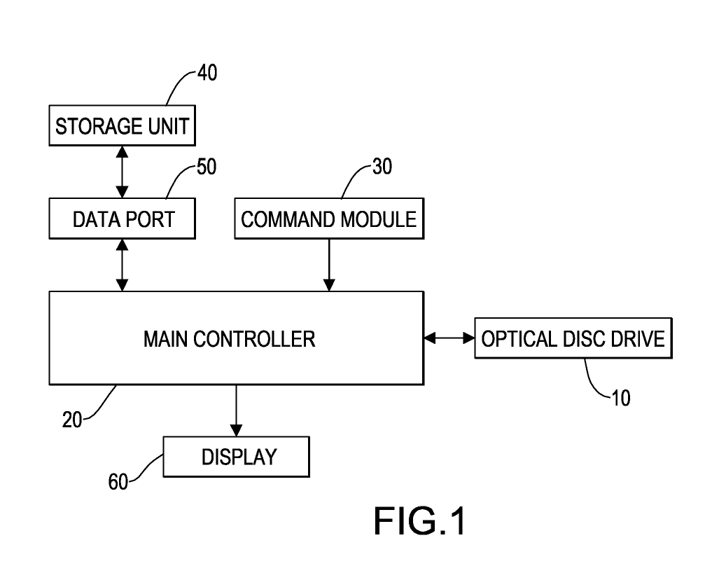

With reference to FIG. 1, a first embodiment of an integrated standalone optical disc duplication and labeling system in accordance with the present invention comprises an optical disc drive (10), a main controller (20), a command module (30), a storage unit (40) and a display (60).

The optical disc drive (10) is capable of containing an optical disc, and the optical disc may be but not limit to CD, DVD, blu-ray or HD DVD. Further, the optical disc drive (10) is capable of performing either a duplication capability to record data to the contained optical disc or a labeling capability to label images on the contained optical disc.

The main controller (20) is connected to the optical disc drive (10) via Parallel Advanced Technology Attachment (PATA) or Serial Advanced Technology Attachment (SATA) with Packet Interface standards to operate the optical disc drive (10).

The command module (30) is connected to the main controller (20) and is capable of transmitting either a duplication designating command or a labeling designating command. Further, the command module (30) may be an input keypad that allows a user to operate the input keypad to designate the optical disc drive (10) to perform either the duplication capability or the labeling capability. The command module (30) follows the user's designations to transmit either the duplication designating command to the main controller (20) to designate the optical disc drive (10) to perform the duplication capability or the labeling designating command to the main controller (20) to designate the optical disc drive (10) to perform the labeling capability.

The storage unit (40) is connected to the main controller (20) via a data port (50). The storage unit (40) may be a built-in storage unit, such as a hard drive or a flash memory mounted in the integrated standalone optical disc duplication and labeling system of the present invention, or an external storage unit, such as a flash memory or a hard drive in an external computer connected externally on the integrated standalone optical disc duplication and labeling system of the present invention. The data port (50) may be a Universal Serial Bus (USB) port, external SATA (eSATA) port, PATA port, SATA port or the like. If the storage unit (40) is a built-in storage unit, the data port (50) may be a PATA port, SATA port or the like. If the storage unit (40) is an external storage unit, the data port (50) may be a USB port, eSATA port or the like. Further, the storage unit (40) stores duplication data and label images. The main controller (20) reads and transfers either the duplication data or the label images to the optical disc drives (10) so the optical disc drive (10) is controlled by the main controller (20) to either record the duplication data to or label the label images on the optical disc contained in the optical disc drive (10).

The display (60) is connected to the main controller (20) to show a data list of the duplication data and the label images. The user can watch the display (60) and operate the command module (30) to designate the optical disc drive (10) to perform either the duplication capability or the labeling capability, and further select the duplication data to be recorded and the label images to be labeled.

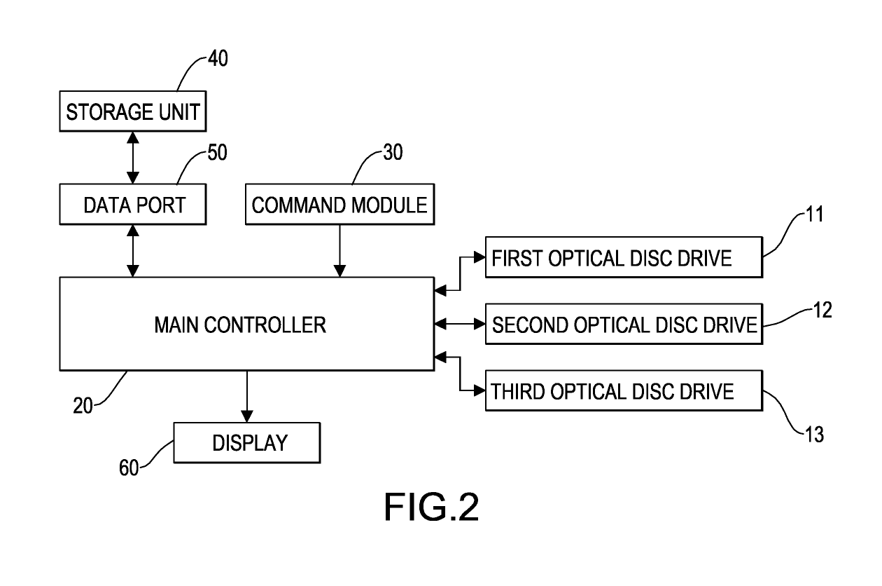

With reference to FIG. 2, a second embodiment of an integrated standalone optical disc duplication and labeling system in accordance with the present invention is similar to the first embodiment of the present invention. Differences between the first embodiment and the second embodiment of the present invention are introduced as follows.

In the second embodiment, a first optical disc drive (11), a second optical disc drive (12) and a third optical disc drive (13) are implemented, and the first, the second and the third optical disc drives (11, 12, 13) are connected to the main controller (20).

The command module (30) is capable of transmitting at least one duplication designating command and at least one labeling designating command and allows the user to operate the command module (30) to designate at least one optical disc drive to perform the duplication capability and at least one optical disc drive to perform the labeling capability. The command module (30) follows the user's designations to transmit at least one duplication designating command to the main controller (20) to designate a corresponding optical disc drive (11, 12, 13) to perform the duplication capability, and transmit at least one labeling designating command to the main controller (20) to designate a corresponding optical disc drive (11, 12, 13) to perform the labeling capability. For example, if the user designates the first optical disc drive (11) to perform the duplication capability and the second and the third optical disc drives (12, 13) to perform the labeling capability via operating the command module (30), the main controller (20) will follow the duplication designating command and the labeling designating commands transmitted from the command module (30) to operate the first optical disc drive (11) to perform the duplication capability and the second and the third optical disc drives (12, 13) to perform the labeling capabilities.

The main controller (20) reads the duplication data and the label images and transfers the duplication data and the label images respectively to the optical disc drives (11, 12, 13) designated by the duplication designating commands and the labeling designating commands so the first, the second and the third optical disc drives (11, 12, 13) are controlled by the main controller (20) to record the duplication data to the optical discs and label the label images on the optical discs.

The display (60) further is capable of showing a drive list of the first, the second and the third optical disc drives (11, 12, 13). The user can watch the display (60) and operate the command module (30) to designate some of the optical disc drives (11, 12, 13) to perform the duplication capabilities and the other optical drives (11, 12, 13) to perform the labeling capabilities.

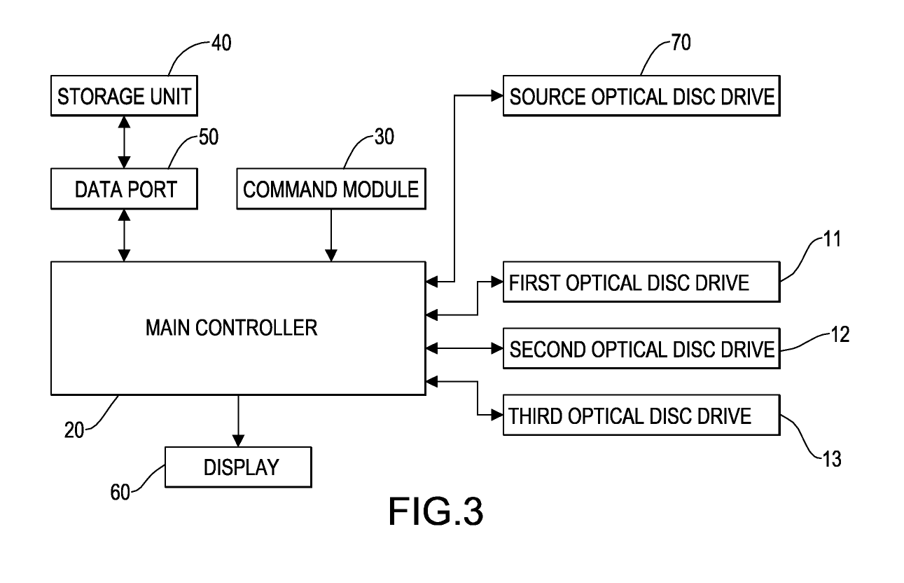

With reference to FIG. 3, a third embodiment of the present invention is similar to the first and the second embodiments of the present invention. Differences between the first and second embodiments and the third embodiment of the present invention are that the system in the third embodiment further has a source optical disc drive (70) and the main controller (20) further has an operating process. Further, in the third embodiment, the storage unit (40) is an external storage unit. The following descriptions introduce the third embodiment of the present invention based on the second embodiment of the present invention.

The source optical disc drive (70) is connected to the main controller (20) via PATA or SATA with Packet Interface standards and is capable of containing a source optical disc. The source optical disc may store the duplication data and the label images. The user can further watch the display (60) and operate the command module (30) to select required duplication data and label images in the storage unit (40) or in the source optical disc. Of course, a person skilled in the art would know that if the required duplication data and label images are in the storage unit (40), the source optical disc drive (70) can perform the same capabilities as the first, the second and the third optical disc drives (11, 12, 13).

The operating process is executed by the main controller (20) and comprises steps of determining whether the storage unit exists (301), determining whether the selected duplication data and the label images are in the storage unit (302), reading the selected duplication data and the label images from the storage unit (303), determining whether the source optical disc is inserted in the source optical disc drive (304), reading the selected duplication data and the label images from the source optical disc (305) and transferring the duplication data and the label images to the optical disc drives (306).

In the step of (301), the main controller (20) determines whether the storage unit (40) exists.

If the storage unit (40) exists, in the step of (302), the main controller (20) further determines whether the selected duplication data and the label images are in the storage unit (40). If not, the operating process goes to an end.

If the selected duplication data and the label images are in the storage unit (40), in the step of (303), the main controller (20) reads the selected duplication data and the label images from the storage unit (40).

If the storage unit (40) does not exist, in the step of (304), the main controller (20) determines whether the source optical disc is inserted in the source optical disc drive (70). If not, the operating process goes to an end.

If the source optical disc is inserted in the source optical disc drive (70), in the step of (305), the main controller (20) reads the selected duplication data and the label images from the source optical disc.

In the step of (306), the main controller (20) transfers the duplication data to the first optical disc drive (11) and the label images to the second and the third optical disc drive (12, 13) if the first optical disc drive (11) is designated to perform the duplication capability and the second and the third optical disc drives (12, 13) are designated to perform the labeling capabilities as exemplified in the first embodiment.

Based on the foregoing descriptions, the invention provides an innovative solution for duplication and labeling with several benefits. The user acquires a single standalone system of the present invention that is able to perform both duplication and labeling. Further, the system of the present invention allows the user to control the optical disc drive (10) to perform either the duplication capability or the labeling capability based on different requirements as disclosed in the first embodiment. Additionally, the system of the present invention allows the user to designate the optical disc drives (11, 12, 13) to perform the duplication capabilities or the labeling capabilities based on different requirements as disclosed in the second and the third embodiments. For example, the first optical disc drive (11) performs the duplication capability and the second and the third optical disc drives (12, 13) perform the labeling capabilities simultaneously in the first embodiment. The combined duplication and labeling throughput will increase tremendously.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. An integrated standalone optical disc duplication and labeling system comprising:
an optical disc drive being capable of containing an optical disc and performing either
a duplication capability to record data to the contained optical disc; or
a labeling capability to label images on the contained optical disc;
a main controller connected to and operating the optical disc drive; and
a command module connected to the main controller and being capable of transmitting either
a duplication designating command to the main controller to operate the optical disc drive to perform the duplication capability; or
a labeling designating command to the main controller to operate the optical disc drive to perform the labeling capability.

2. The system as claimed in claim 1 further comprises a storage unit, wherein
the storage unit is connected to the main controller via a data port and stores duplication data and label images so the main controller transfers either the duplication data or the label images to the optical disc drive; and
the optical disc drive is controlled by the main controller to either record the duplication data to or label the label images on the optical disc contained in the optical disc drive.

3. The system as claimed in claim 1 further comprises a source optical disc drive, wherein
the source optical disc drive is connected to the main controller and is capable of containing a source optical disc, and the optical disc stores duplication data and label images so the main controller transfers either the duplication data or the label images to the optical disc drive; and
the optical disc drive is controlled by the main controller to either record the duplication data to or label the label images on the optical disc contained in the optical disc drive.

4. The system as claimed in claim 2 further comprises a source optical disc drive, wherein
the source optical disc drive is connected to the main controller and is capable of containing a source optical disc, and the optical disc stores duplication data and label images so the main controller transfers either the duplication data or the label images to the optical disc drive; and
the optical disc drive is controlled by the main controller to either record the duplication data to or label the label images on the optical disc contained in the optical disc drive.

5. The system as claimed in claim 4, wherein the main controller further has and executes an operating process comprising steps of:
determining whether the storage unit exists;
determining whether the selected duplication data and the label images are in the storage unit if the storage unit exists;
reading the selected duplication data and the label images from the storage unit if the selected duplication data and the label images are in the storage unit;
determining whether the source optical disc is inserted in the source optical disc drive if the storage unit does not exist;
reading the selected duplication data and the label images from the source optical disc; and
transferring the duplication data and the label images to the optical disc drives after reading the selected duplication data and the label images.

6. The system as claimed in claim 1 further comprises a display, wherein the display is connected to the main controller to show a data list of the duplication data and the label images.

7. The system as claimed in claim 2 further comprises a display, wherein the display is connected to the main controller to show a data list of the duplication data and the label images.

8. The system as claimed in claim 3 further comprises a display, wherein the display is connected to the main controller to show a data list of the duplication data and the label images.

9. The system as claimed in claim 4 further comprises a display, wherein the display is connected to the main controller to show a data list of the duplication data and the label images.

10. The system as claimed in claim 5 further comprises a display, wherein the display is connected to the main controller to show a data list of the duplication data and the label images.

11. An integrated standalone optical disc duplication and labeling system comprising:
multiple optical disc drives, and each optical disc drive being capable of containing an optical disc and performing either
a duplication capability to record data to the contained optical disc; or
a labeling capability to label images on the contained optical disc;
a main controller connected to the optical disc drives and operating the optical disc drives; and
a command module connected to the main controller and being capable of transmitting
at least one duplication designating command to the main controller to designate a corresponding optical disc drive to perform the duplication capability; and
at least one labeling designating command to the main controller to designate a corresponding optical disc drive to perform the labeling capability.

12. The system as claimed in claim 11 further comprises a storage unit, wherein
the storage unit is connected to the main controller via a data port and stores duplication data and label images so the main controller transfers the duplication data and the label images respectively to the optical disc drive designated by the at least one duplication designating command and the at least one labeling designating command; and
the optical disc drives are controlled by the main controller to record the duplication data to the optical discs and label the label images on the optical discs based on the at least one duplication designating command and the at least one labeling designating command.

13. The system as claimed in claim 11 further comprises a source optical disc drive, wherein
the source optical disc drive is connected to the main controller and is capable of containing a source optical disc, and the optical disc stores duplication data and label images so the main controller transfers either the duplication data or the label images to the optical disc drive; and
the optical disc drives are controlled by the main controller to record the duplication data to the optical discs and label the label images on the optical discs based on the at least one duplication designating command and the at least one labeling designating command.

14. The system as claimed in claim 12 further comprises a source optical disc drive, wherein
the source optical disc drive is connected to the main controller and is capable of containing a source optical disc, and the optical disc stores duplication data and label images so the main controller transfers either the duplication data or the label images to the optical disc drive; and
the optical disc drives are controlled by the main controller to record the duplication data to the optical discs and label the label images on the optical discs based on the at least one duplication designating command and the at least one labeling designating command.

15. The system as claimed in claim 14, wherein the main controller further has and executes an operating process comprising steps of:
determining whether the storage unit exists;
determining whether the selected duplication data and the label images are in the storage unit if the storage unit exists;
reading the selected duplication data and the label images from the storage unit if the selected duplication data and the label images are in the storage unit;
determining whether the source optical disc is inserted in the source optical disc drive if the storage unit does not exist;
reading the selected duplication data and the label images from the source optical disc; and
transferring the duplication data and the label images to the optical disc drives after reading the selected duplication data and the label images.

16. The system as claimed in claim 11 further comprises a display, wherein the display is connected to the main controller to show a drive list of the optical disc drives and a data list of the duplication data and the label images.

17. The system as claimed in claim 12 further comprises a display, wherein the display is connected to the main controller to show a drive list of the optical disc drives and a data list of the duplication data and the label images.

18. The system as claimed in claim 13 further comprises a display, wherein the display is connected to the main controller to show a drive list of the optical disc drives and a data list of the duplication data and the label images.

19. The system as claimed in claim 14 further comprises a display, wherein the display is connected to the main controller to show a drive list of the optical disc drives and a data list of the duplication data and the label images.

20. The system as claimed in claim 15 further comprises a display, wherein the display is connected to the main controller to show a drive list of the optical disc drives and a data list of the duplication data and the label images.
